(19) United States
(12) Patent Application Publication
(10) Pub. No.: US 2010/0318687 A1
(43) Pub. Date: Dec. 16, 2010

(54) METHOD AND APPARATUS FOR FORMATTING NETWORK-ATTACHED STORAGE

(76) Inventor: Shu-Kai Ho, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/556,581

(22) Filed: Sep. 10, 2009

(30) Foreign Application Priority Data
Jun. 15, 2009 (TW) 098119915

(51) Int. Cl. G06F 13/10

(52) U.S. Cl. 710/10

(57) ABSTRACT

A method for formatting a network-attached storage (NAS) includes: coupling the NAS to a user-end personal computer (PC) via an external bus which supports a plug and play function; and utilizing the user-end PC to format a storage device of the NAS via the external bus. A network-attached storage includes a storage device, and a bus interface for coupling an external bus which supports a plug and play function such that the storage device of the NAS is formatted via the external bus.

### BACKGROUND OF THE INVENTION

1. Field of the Invention

The present invention relates to a network storage system, and more particularly, to a method and apparatus for formatting a network-attached storage.

2. Description of the Prior Art

A network-attached storage (NAS) is a file-level computer data storage connected to a network, for providing data access to heterogeneous network clients. The NAS is directly connected to a local area network (LAN), and supports multiple file-based protocols. Please refer to FIG. 1. FIG. 1 is a diagram illustrating a conventional NAS system 100. As shown in FIG. 1, a NAS 110 is connected to a user-end personal computer (PC) 130 via an Ethernet 120. The NAS 110 is connected to the user-end PC 130 or other developed dedicated file servers via the Ethernet 120, for managing the data files stored on a network and providing common data storage protocols between different servers and workstations based on the internet protocol (IP). Because the NAS (serving as a file server) is optimized and dedicated to providing storage services, other servers can run tasks without allocating system resources to provide the storage services. One of the major advantages of the NAS is that the NAS can allocate storage space to different servers and workstations, and the data files can be shared on the network.

The difference between the NAS and a conventional data storage service or a direct storage apparatus is that the operating system (OS) and software of the NAS only provides the functionality of data storage, file systems, access to files, and the management of these functionalities. Additionally, the NAS usually contains one or more hard disks, often arranged as RAID arrays (Redundant Arrays of Inexpensive/Independent Disks). The NAS usually utilizes a second extended file system (EXT2 file system) or third extended file system (EXT3 file system) as its file system.

Conventionally, the NAS provides data access services via the network. Upon first use, the prior art design performs an initialization setup to configure the NAS via an Ethernet interface, and then formats the NAS utilizing the processor and software implemented in the NAS through the Ethernet interface. However, it is difficult to connect to the NAS via the Ethernet interface when the configuration of the network is not yet completed. Therefore, how to format the NAS easily and effectively is an issue that needs to be resolved.

### SUMMARY OF THE INVENTION

It is therefore one of the objectives of the present invention to provide a method for formatting a network-attached storage (NAS) and a related apparatus, in order to solve the above-mentioned problems.

According to an embodiment of the present invention, a method for formatting a NAS is disclosed. The method includes: coupling the NAS to a user-end personal computer (PC) via an external bus which supports a plug & play function; and utilizing the user-end PC to format a network interface of the NAS via the external bus.

According to another embodiment of the present invention, a NAS is disclosed. The NAS includes a storage device, a bus interface, an internal firmware and a processor. The bus interface is used for connecting to an external bus which supports a plug & play function such that the storage device of the NAS is formatted via the external bus. The processor is coupled to the internal firmware, and implemented for executing the internal firmware implemented in the NAS.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional network-attached storage system.

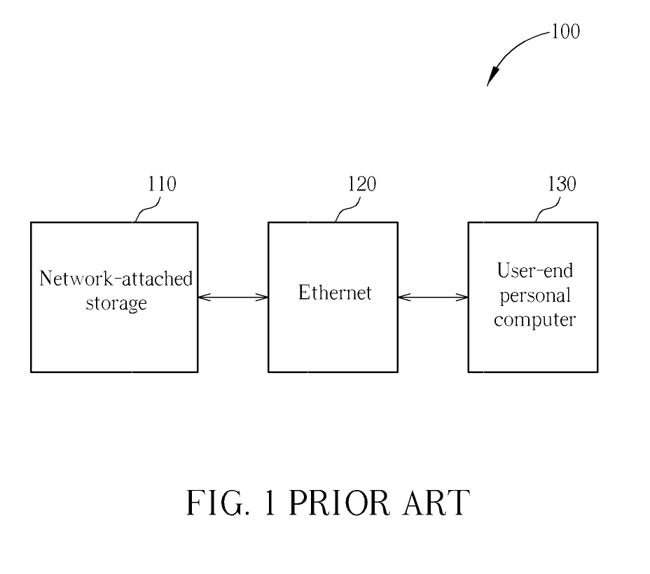

FIG. 2 is a diagram illustrating a network-attached storage system according to an exemplary embodiment of the present invention.

FIG. 3 is a flowchart illustrating a method for formatting the network-attached storage system shown in FIG. 2 according to an exemplary embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

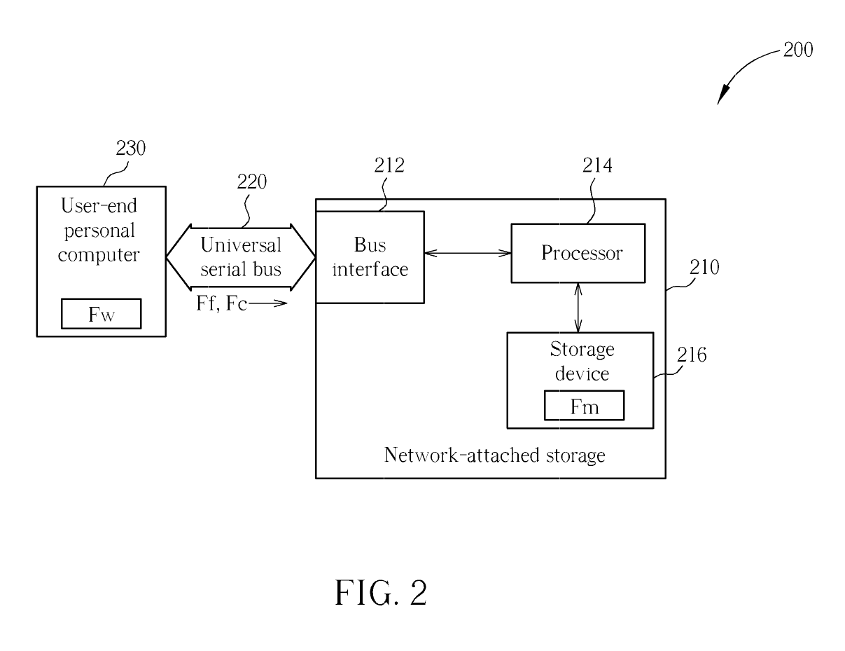

Please refer to FIG. 2. FIG. 2 is a diagram illustrating a network-attached storage (NAS) system 200 according to an exemplary embodiment of the present invention. In this embodiment, the NAS system 200 includes, but is not limited to, a NAS 210, a universal serial bus (USB) 220 and a user-end personal computer (PC) 230. Please note that the USB 220 is an external bus which supports a plug & play function in this exemplary embodiment; however, this is for illustrative purposes only, and is by no means a limitation to the scope of the present invention. Using another external bus (e.g. IEEE 1394 bus) that also supports the plug & play function also falls within the scope of the present invention. The NAS 210 includes a bus interface 212 and a processor 214. The bus interface 212 is used for connecting with the USB 220 in order to receive a connecting command Fc outputted by the user-end PC 230 via the USB 220. The processor 214 is coupled to the bus interface 212, for connecting the NAS 210 to the user-end PC 230 according to the connecting command Fc received by the bus interface 212.

The NAS 210 further includes an internal firmware Fm and a storage device 216. The storage device 216 is coupled to the processor 214, for storing data and the internal firmware Fm. The processor 214 is implemented to execute the internal firmware Fm to receive the connecting command Fc outputted by the user-end PC 230 via the USB 220, and connects the storage device 216 of the NAS 210 to the user-end PC 230 according to the connecting command Fc. Additionally, the user-end PC 230 utilizes a formatting software Fw which supports the NAS 210 to generate a formatting command Ff, for directly formatting the storage device 216 of the NAS 210 via the USB 220.

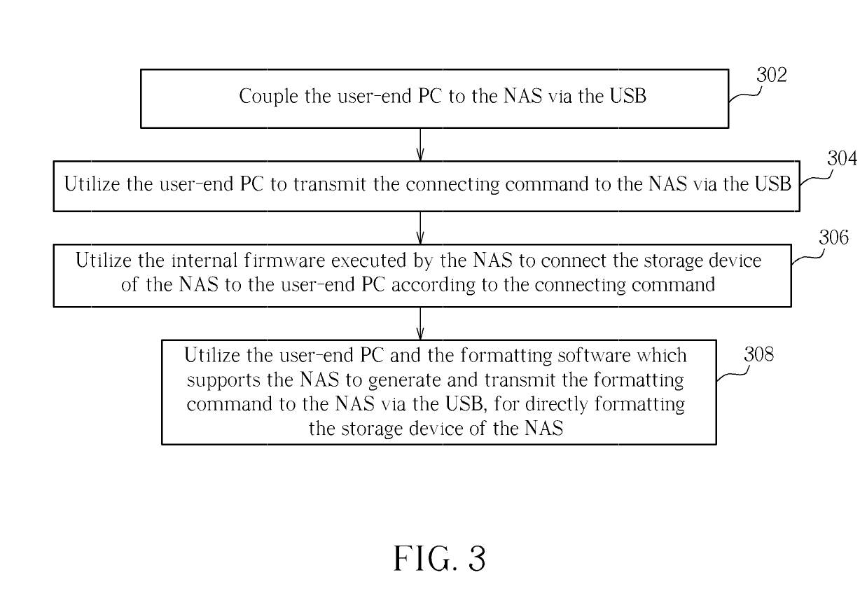

Please refer to FIG. 3 in conjunction with FIG. 2. FIG. 3 is a flowchart illustrating a method for formatting the network-attached storage system 200 shown in FIG. 2 according to an exemplary embodiment of the present invention. Please note that, provided the same result is substantially achieved, the steps of the flowchart shown in FIG. 3 need not be in the exact order shown and need not be contiguous; that is, other steps can be intermediate. The exemplary method for formatting the network-attached storage system 200 includes the following steps:

Step 302: Couple the user-end PC 230 to the NAS 210 via the USB 220.

Step 304: Utilize the user-end PC 230 to transmit the connecting command Fc to the NAS 210 via the USB 220.

Step 306: Utilize the internal firmware Fm executed by the NAS 210 to connect the storage device 216 of the NAS 210 to the user-end PC 230 according to the connecting command Fc.

Step 308: Utilize the user-end PC 230 and the formatting software Fw which supports the NAS 210 to generate and transmit the formatting command Ff to the NAS 210 via the USB 220, for directly formatting the storage device 216 of the NAS 210.

In summary, the present invention provides a method and related apparatus for formatting a NAS. Since the present invention utilizes an external bus which supports a plug & play function to connect a user-end PC and a NAS, the configuration problem of the NAS is solved. The external bus can be used to format a storage device of the NAS before the network interface of the NAS is successfully configured. In this way, the complex step of formatting the storage device of the NAS via the Ethernet can be avoided.

Those skilled in the art will readily observe that numerous modifications and alterations of the device and method may be made while retaining the teachings of the invention.

What is claimed is:

1. A method for formatting a network-attached storage (NAS), comprising:
coupling the network-attached storage to a user-end personal computer (PC) via an external bus which supports a plug & play function; and
utilizing the user-end PC to format a storage device of the NAS via the external bus.

2. The method of claim 1, wherein the external bus is a universal serial bus (USB).

3. The method of claim 1, wherein the external bus is an IEEE 1394 bus.

4. The method of claim 1, wherein the step of utilizing the user-end PC to format the storage device of the NAS via the external bus comprises:
utilizing the user-end PC to transmit a connecting command to the NAS via the external bus;
utilizing an internal firmware executed by the NAS to connect the storage device of the NAS to the user-end PC according to the connecting command; and
utilizing the user-end PC and a formatting software which supports the NAS to generate and transmit a formatting command to the NAS via the USB, for directly formatting the storage device of the NAS.

5. A network-attached storage (NAS), comprising:
a storage device; and
a bus interface, for connecting with an external bus which supports a plug & play function, wherein the storage device of the NAS is formatted via the external bus.

6. The NAS of claim 5, wherein the external bus is a universal serial bus (USB).

7. The NAS of claim 5, wherein the external bus is an IEEE 1394 bus.

8. The NAS of claim 5, further comprising:
an internal firmware; and
a processor, coupled to the internal firmware, for executing the internal firmware implemented in the NAS;
wherein the processor executes the internal firmware to receive a connecting command outputted by a user-end PC via the external bus, and connects the storage device of the NAS to the user-end PC according to the connecting command; and the storage device receives a formatting command from the user-end PC via the external bus to directly perform formatting operations after the storage device of the NAS has been coupled to the user-end PC via the external bus.
